(19) United States
(12) Patent Application Publication
(10) Pub. No.: US 2016/0143235 A1
(43) Pub. Date: May 26, 2016

(54) HYDROPONIC DEVICE HAVING TRANSPARENT PROPAGATION TRAY

(71) Applicants: Daniel Torres, Glendale, CA (US); Jeffrey Malinovitz, Woodland Hills, CA (US)

(72) Inventors: Daniel Torres, Glendale, CA (US); Jeffrey Malinovitz, Woodland Hills, CA (US)

(21) Appl. No.: 14/943,864

(22) Filed: Nov. 17, 2015

Related U.S. Application Data
(60) Provisional application No. 62/084,473, filed on Nov. 25, 2014.

(51) Int. Cl. A01G 31/02

(52) U.S. Cl. CPC A01G 31/02

(57) ABSTRACT

A hydroponic growing device having a transparent dome positioned over a transparent propagation tray contained within an opaque catch tray and a locking mechanism for rigidly connecting the transparent dome with the transparent propagation tray and the catch tray.

### CROSS-REFERENCE TO RELATED APPLICATION(S)

This application claims the benefit of and priority to U.S. Provisional Application No. 62/084,473 filed Nov. 25, 2014, the entire contents of which are incorporated herein by reference.

### FIELD OF THE INVENTION

The present invention relates generally to hydroponic propagation devices and more particularly a hydroponic device having a transparent propagation tray.

### BACKGROUND ON THE INVENTION

Plant propagation can better be defined as the process of creating new plants from a variety of sources, mainly seeds, cuttings, bulbs, or other plant parts. Success for plant propagation depends upon the successful formation of roots from the seeds or clone cuttings. The ability to detect when the seed or cutting actually produces roots is paramount. Plant propagation through seeds and cuttings is typically done in a tray and to check on root growth, the growing medium is manually lifted to check for the roots. Manually lifting the growing medium to check for root growth can have the negative effect of damaging tender or beginning roots as well as giving false readings as to how well the seeds are sprouting roots throughout the entire tray. A thorough checking would require moving the medium through multiple locations throughout the tray which compounds the problem.

Considering seed germination requires a dark environment, utilizing transparent trays deters root growth. Considering large scale plant propagation through seeds or cuttings requires root growth monitoring to be efficient so that only the proper length of time expires before seedlings are transferred from a hydroponic propagation trays to pots or other growing containers, it is important to be able to monitor root growth on a continual basis without disturbing the growing medium.

Consequently a need exists for an improved hydroponic device having the capability of quickly and continually monitoring root growth without disturbing the growing medium.

### SUMMARY OF THE INVENTION

The present invention provides a hydroponic device having a transparent propagation tray which addresses the problems associated with prior hydroponic devices. The hydroponic device comprises three components, a transparent dome which can regulate humidity within the dome, a transparent internal propagation tray having grooves to allow water to channel out through a plurality of drain holes, and an opaque catch tray adapted to contain the transparent internal propagation tray so that there is no light penetration to damage or prevent the roots from growing. The transparent internal propagation tray and the opaque catch tray sit flush with one another without a significant difference in height between the two different surfaces and provide no obstruction or interference between them.

The transparent dome includes two ventilation sites to regulate airflow to reduce moisture loss to seedlings and plant cuttings. The dome includes a locking mechanism to alleviate any damage during transporting the device and prevent damage to plants as a result of the dome coming apart from the trays. Previously domes were attached to a tray using adhesive masking or packing tape or other inefficient methods. An internal locking feature eliminates unwanted adhesive residue and properly secures the components from unwanted separation.

The dome can also be fitted with an integral thermometer and hygrometer which could include a digital display that enables a user to monitor and determine both the adequate temperature and humidity levels for optimal growth within the device. Having an internal thermometer and hygrometer eliminates removal of the dome and the use of external temperature and humidity probes.

The second component of the hydroponic device is the propagation tray which is a durable transparent tray which allows water to pass through small drain holes located at the bottom of the tray and into the catch tray. The transparent tray includes grooves to allow for water to channel out through the drainage holes. The transparent internal propagation tray facilitates the observation of root protrusion by simply lifting the tray out of the catch tray and looking at the clear underside of the tray. With the naked eye, and without the need to disturb the growing medium, root growth can be observed from the seedlings and cuttings. This observation allows the user to determine when the seedlings are ready to be transferred to the next larger container. Growing medium is positioned in the propagation tray and can be a substance through which roots grow and extract water and nutrients. Rockwool or mineral wool which is an inorganic fiber substance that is produced by steam-blasting and cooling molten glass or a similar substance and is used as an insulator and filtering material. The roots that grow through this material then protrude through an out the rockwool at which point the material is taken from the trays and transplanted into a larger container for more developmental growth.

The third component of the hydroponic device is the catch tray which is made from a durable completely opaque polymer, particularly black in color, to prevent any light from sun or lamps from coming into contact with the growing medium from the underside of the transparent tray. If roots come in contact with light, they cease to grow, withering and eventually dying. Thus the catch tray encloses the transparent tray and serves as a housing unit as the transparent tray fits snugly inside of the catch tray. The dimensions of the catch tray coincide with the dimensions of the transparent tray.

The catch tray can include a detachable heating pad incorporated within the exterior grooves of the tray. The heating element can be insulated rubber-covered coils. A digital temperature control gauge is attached to the power cord of the heating element. In plant propagation, heating is an important element for root development and root growth. Heat provides a critical environment necessary in the developmental environment for seedlings and cuttings. Incorporating a heating element facilitates the success rate of root propagation and decreases the rooting time significantly. The propagation device of the present invention is not intended to house a plant for a long duration of time and is merely a temporary housing until the plant has visible root development and can be moved to a more permanent container for continued growth.

### BRIEF DESCRIPTION OF THE DRAWINGS

FIG. 1 is a side view of the hydroponic device of the present invention;

FIG. 2 is a top view of the dome of the device of FIG. 1;

FIG. 3 is a top view of the transparent propagation tray of the device of FIG. 1;

FIG. 4 is a top view of the catch tray of the device of FIG. 1.

### DETAILED DESCRIPTION

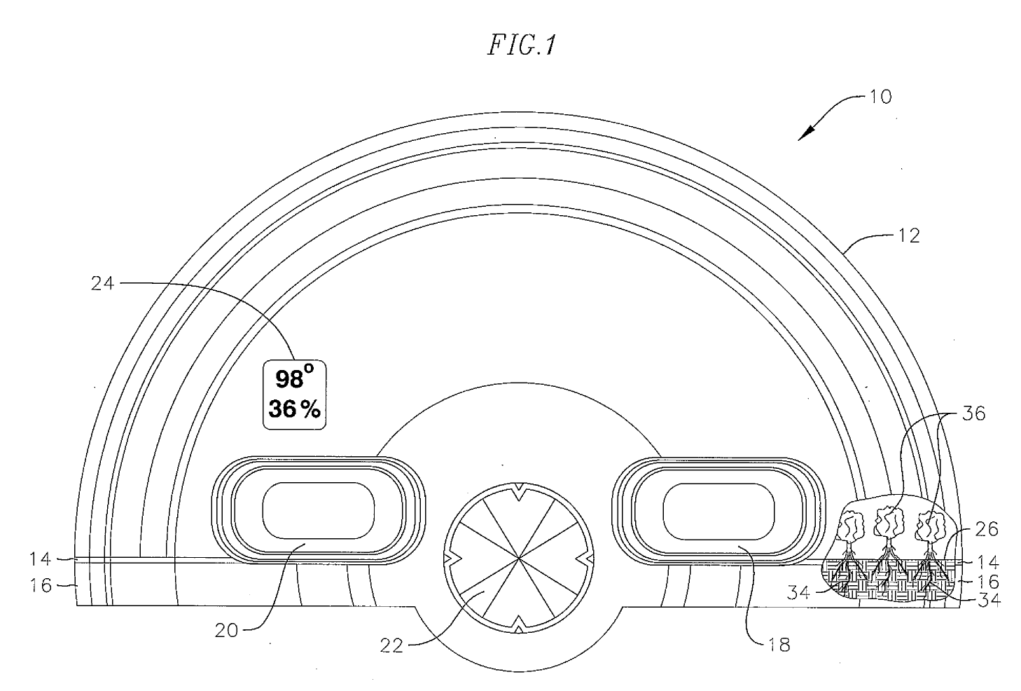

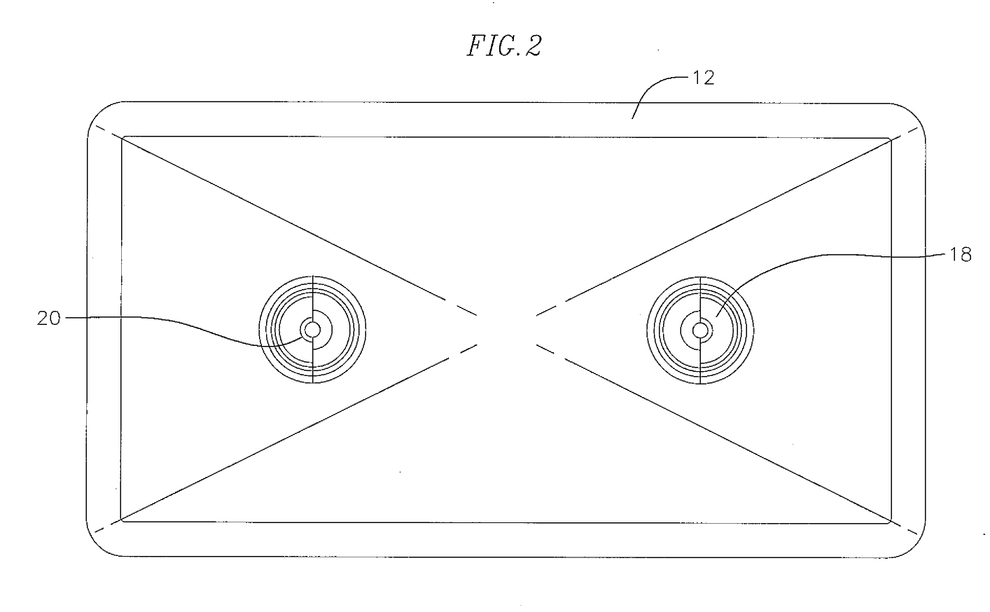

Referring to FIGS. 1-4, the present invention is a hydroponic device 10 for the propagation of plants comprising a transparent dome 12 positioned on top of a transparent propagation tray 14 which both are positioned on an opaque catch tray 16. As also can be seen in FIG. 2 the dome 12 is transparent and is made from polyvinyl chloride (PVC) and includes one or more vents 18, 20 which regulates humidity with inside the dome within the device. The overall shape of the dome 12 is hemispherical having a generally rectangular perimeter, however the size and dimensions can be changed depending upon the particular plants being propagated. As mentioned, the dome is made from a durable transparent plastic, such as PVC wherein vents 18, 20 can be in either an open or closed position to regulate airflow to reduce moisture loss to seedlings and plant cuttings contained within the device. For example, the dome can be 7 inches tall and approximately 10.25 inches wide by 20.25 inches long. Typically the dome would be manufactured through plastic injection molding processes. Although the dome is commonly made of a polymer such as PVC, other plastic materials could also be incorporated. To adjust the flexibility or rigidity of the dome, the polymer can be mixed with plasticizers such as phthalate esters, which increase the plasticity or fluidity of the material. As seen in FIG. 1, the dome includes a locking mechanism 22 in order to keep the assembly together during transport or movement. The locking mechanism is in the form of a button which allows the dome to be snapped onto the propagation tray 14 and catch tray 16. The locking mechanism enables safe transportation of the device from one location to the next without potential damage to the cuttings as a result of the dome coming apart from the trays. The locking feature eliminates the use of adhesive masking or packing tape or other traditional methods to keep the units together. The locking button also eliminates adhesive residue. Other types of locking features could also be incorporated into the dome to maintain the device in an assembled condition such as perimeter closures or equivalents thereof.

The propagation dome 12 could also be fitted and adapted with an internal thermometer and hygrometer reader 24 having a digital display that enables the user of the device to monitor and determine both the temperature and humidity levels within the device for optimal growth therein. By incorporating internal thermometer and hygrometer devices eliminates the need to remove the dome and use external temperature and humidity probes which would affect the humidity and temperature conditions within the device when the dome is removed from the trays.

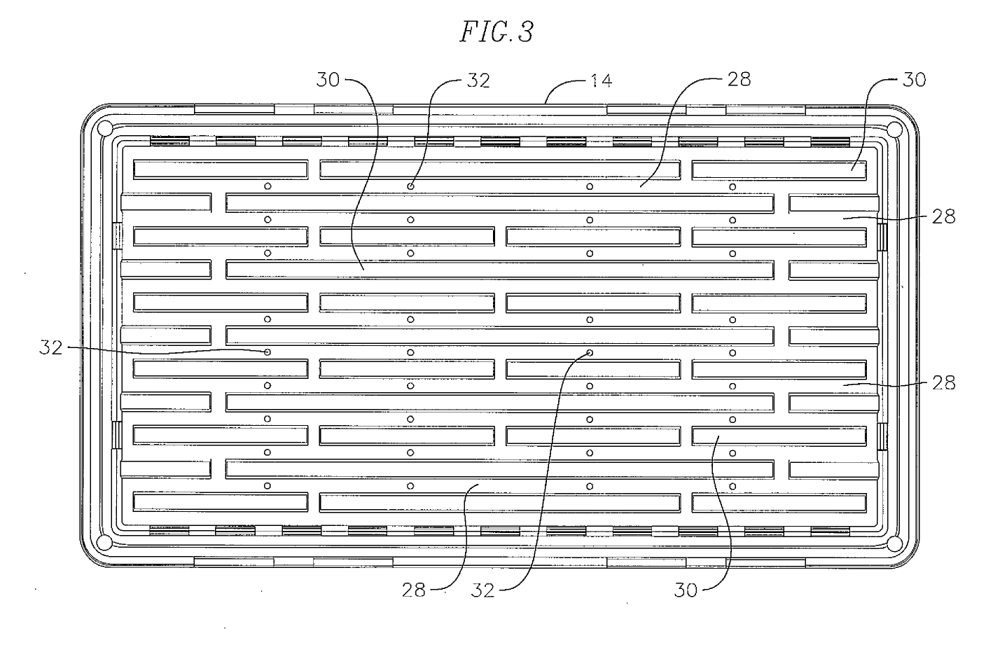

As shown in FIG. 3, the propagation tray 14 also is a transparent plastic tray also made from PVC material or other polymers. The transparent propagation tray 14 can also have its durability or rigidity modified by mixing plasticizers with the polymer material. Less plasticizer will be used to allow for a more rigid and thicker component to allow for support of a growing medium 26 (FIG. 1). The transparent propagation tray 14 includes a plurality of channels 28 interconnected in the base of the tray which are separated by a network of raised ridges 30. Water drainage holes 32 are spaced throughout the network of channels 28 to allow for water to pass out of the propagation tray and into the catch tray 16. Although multiple geometric configurations of the tray are available depending upon the requirements for this specific plant being propagated, typically the tray will be generally triangular and approximately 10.25 inches wide by 20.25 inches long corresponding to the dome. The height of the tray can for example be approximately 3 inches.

In order to observe the root development of the plants being propagated the transparent propagation tray can be manually lifted from the catch tray to observe root growth 34 of plants 36 (FIG. 1) being propagated by viewing the roots from underneath the propagation tray. Root growth can be viewed with the naked eye and without disturbing the growing medium 26 as the tray is transparent and can be looked through. The user can then determine when the plants are ready to be transferred to the next larger growing container.

The growing medium 26 can be any appropriate growing medium used in propagation of seedlings or other plants, but can be for example a substance through which roots grow and extract water and nutrients. More commonly, rockwool or mineral wool is utilized which is an inorganic fibrous substance that is produced by steam blasting and cooling molten glass or a similar substance and is used as an insulator and filtering material for seedlings and cuttings. The roots that grow through the growing medium then protrude through and out at which point the plant can be removed from the trays and transplanted into a larger container for more developmental growth.

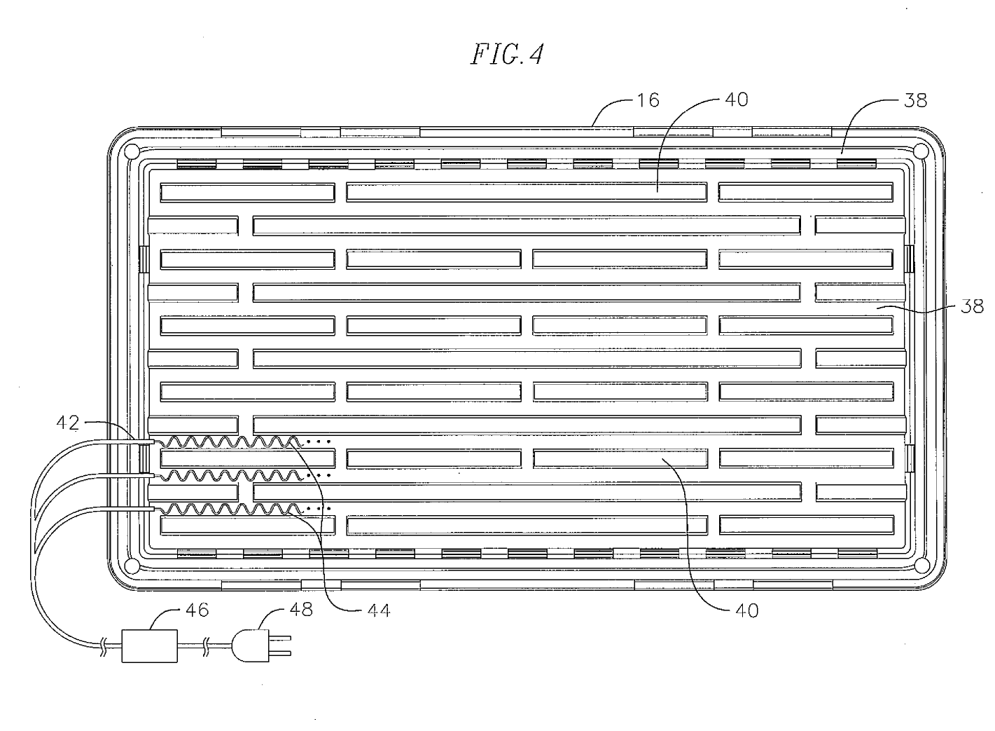

As seen in FIG. 4 the catch tray 16 is made of a durable plastic and is completely opaque, typically black in color, to prevent any light from sun or lamps from coming in contact with the grow medium underside. If roots come in contact with light, they cease to grow, withering and eventually dying. Thus the catch tray is designed to enclose the propagation tray. The catch tray serves as a housing unit and has the same configuration as the propagation tray so that the propagation tray fits snuggly inside the catch tray. Consequently, the catch tray has a series of channels 38 mirroring those of the propagation tray. The catch tray also is substantially rectangular similar to the propagation tray. The catch tray can incorporate a detachable heating pad which can either be incorporated on the interior in the channels 38 or on the exterior of the tray in the raised projections 40 for controlling the temperature within the device. The heating element includes insulated rubber-covered coils 44 and includes a digital temperature control gauge 46 attached to the power cord 48. Considering the heating pad is detachable, the power cord or power source can be left at the site when the device is moved or can be transferred with the device. In plant propagation, heating is an important element for root development and root growth. The proper temperature is crucial in creating a developmental environment for seedlings and cuttings and facilitates the success rate and decreases the rooting time significantly.

The propagation device of the present invention is a temporary housing for visible root development and is not intended to house a plant for any long duration of time. Consequently, maintaining proper growing conditions and providing the ability to monitor root growth without disturbing the plant are critical.

Although the present invention has been described and illustrated with respect to a preferred embodiment thereof, it is to be understood that changes and modifications can be made therein which are within the full intended scope of the invention as hereinafter claimed.

What is claimed is:

1. A hydroponic device comprising:
a transparent dome;
a transparent propagation tray positioned under the dome; and
an opaque catch tray for receipt of the transparent propagation tray.

2. The device of claim 1 wherein the dome has at least one ventilation site that can be in an open or closed position.

3. The device of claim 1 wherein the dome has a locking mechanism to rigidly attach the dome to the propagation tray and the catch tray.

4. The device of claim 3 wherein the locking mechanism is a button.

5. The device of claim 1 wherein the dome includes a thermometer and a hygrometer.

6. The device of claim 1 wherein the propagation tray has a series of channels for circulation of water within the propagation tray.

7. The device of claim 6 wherein the channels are defined by a series of raised ridges spaced within the propagation tray.

8. The device of claim 6 wherein the channels have drain holes.

9. The device of claim 1 wherein the catch tray has a detachable heating pad.

10. The device of claim 9 wherein the heating pad has a plurality of insulated heating coils and a temperature control gauge.

11. A hydroponic growing device comprising:
a transparent dome;
a transparent propagation tray positioned under the dome;
an opaque catch tray for receipt of the transparent dome and the transparent propagation tray; and
means for locking the transparent dome, transparent propagation tray and opaque catch tray together.

12. The device of claim 11 wherein the dome has two vents positionable in an open or closed condition.

13. The device of claim 11 wherein the means for locking is positioned on the dome for locking engagement with the propagation tray and the catch tray.

14. The device of claim 13 wherein the locking mechanism is a button.

15. The device of claim 11 wherein the dome includes a thermometer and a hygrometer.

16. The device of claim 11 wherein the propagation tray has a series of channels for circulation of water within the propagation tray.

17. The device of claim 16 wherein the channels are defined by a series of ridges spaced within the propagation tray

18. The device of claim 16 wherein the channels have drain holes.

19. The device of claim 11 wherein the catch tray has a detachable heating pad.

20. The device of claim 19 wherein the heating pad has a plurality of insulated heating coils and a temperature control gauge.
